(19) United States
(12) Patent Application Publication
(10) Pub. No.: US 2010/0126331 A1
(43) Pub. Date: May 27, 2010

(54) METHOD OF EVALUATING VOCAL PERFORMANCE OF SINGER AND KARAOKE APPARATUS USING THE SAME

(75) Inventors: Dmitry GOLOVKIN, Suwon-si (KR); Chul-min Choi, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/505,027

(22) Filed: Jul. 17, 2009

(30) Foreign Application Priority Data
Nov. 21, 2008 (KR) 2008-116291

(51) Int. Cl. G10H 1/36

(52) U.S. Cl. 84/610

(57) ABSTRACT

A method of evaluating a vocal performance of a singer of a karaoke apparatus includes extracting a voice energy, extracting a reference pitch, and comparing the voice energy and an energy corresponding to the reference pitch and evaluating the vocal performance of the singer.

### CROSS-REFERENCE TO RELATED APPLICATIONS

This application claims the benefit under 35 U.S.C. §119(a) of Korean Patent Application No. 10-2008-116291, filed on Nov. 21, 2008, in the Korean Intellectual Property Office, the disclosure of which is incorporated herein by reference in its entirety.

### BACKGROUND

1. Field of the Invention

The present general inventive concept relates to a method of evaluating a vocal performance of a singer and a karaoke apparatus to perform the method, and more particularly, to a method of evaluating the vocal performance of the singer by comparing a total voice energy of the singer and an energy corresponding to a reference pitch, and a karaoke apparatus to perform the method.

2. Description of the Related Art

Various karaoke apparatuses used to evaluate the vocal performance of a singer have been developed. A method used in a conventional karaoke apparatus is to rate a singer's skill according to whether the singer releases an appropriate level of voice energy at a specific time. This method is advantageous in that it can be simply realized but has a problem in that the accuracy of a pitch is not considered.

In order to solve the above problem, a method using an accompaniment melody has been used. The method using an accompaniment melody rates a singer's skill according to whether the singer's pitch harmonizes with the accompaniment melody. However, this method requires massive computation and has a problem in that an octave error cannot be accurately extracted. Also, the accompaniment melody may not be considered as always harmonizing with the singer's melody.

Accordingly, there is a demand for a method of evaluating the vocal performance of a singer more accurately and also requiring less computation.

### SUMMARY

Example embodiments of the present general inventive concept provide a method of evaluating the vocal performance of a singer more accurately and a karaoke apparatus to perform the method.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a method of evaluating a vocal performance of a singer using a karaoke apparatus, the method including extracting a voice energy of a singer, extracting a reference pitch using musical instrument digital interface (MIDI) data, and comparing the voice energy and an energy of the reference pitch and evaluating the vocal performance of the singer.

The extracting the reference pitch may include extracting the reference pitch using a frequency of a note included in the MIDI data.

The extracting the reference pitch may include extracting the energy of the reference pitch using the Goertzel algorithm.

The energy of the reference pitch may be extracted using the following equation:

P_{B}=2 cos(2 πf)sᵢ₋₁sᵢ₋₂+sᵢ₋₁sᵢ₋₁+sᵢ₋₂sᵢ₋₂

wherein sᵢ=xᵢ+2 cos(2 πf)sᵢ₋₁−sᵢ₋₂, P_{B} denotes the energy of the reference pitch, f denotes the frequency of the note, and xᵢ denotes an input sample.

The extracting the voice energy may include converting a voice of the singer into a digital signal, dividing the digital signal into a plurality of frames, and extracting the voice energy of each of the frames.

The voice energy may be extracted using the following equation:

$${P}_{A} = {\sum }_{i = 1}^{N} {X}_{i}^{2}$$

wherein P_{A} denotes the voice energy, Xᵢ denotes an input sample, and N denotes the size of a frame.

The foregoing and/or other features and utilities of the present general inventive concept may also be achieved by providing a karaoke apparatus including a voice energy extraction unit to extract a voice energy of a singer, a reference pitch extraction unit to extract a reference pitch using MIDI data, and a control unit to evaluate vocal performance of the singer using the voice energy and an energy of the reference pitch.

The reference pitch energy extraction unit may extract the reference pitch using a frequency of a note included in the MIDI data.

The reference pitch energy extraction unit may use the following equation by applying the Goertzel algorithm, which is constituted depending on the reference pitch:

P_{B}=2 cos(2 πf)sᵢ₋₁sᵢ₋₂+sᵢ₋₁sᵢ₋₁+sᵢ₋₂sᵢ₋₂

wherein sᵢ=xᵢ+2 cos(2 πf)sᵢ₋₁−sᵢ₋₂, P_{B} denotes the energy of the reference pitch, f denotes the frequency of the note, and xᵢ denotes an input sample.

The karaoke apparatus may further include a conversion unit to convert a voice of the singer into a digital signal, and the voice energy extraction unit may divide the digital signal into a plurality of frames and extract the voice energy of each of the frames.

The voice energy extraction unit may extract the voice energy using the following equation:

$${P}_{A} = {\sum }_{i = 1}^{N} {X}_{i}^{2}$$

wherein P_{A} denotes the voice energy, Xᵢ denotes an input sample, and N denotes the size of a frame.

The foregoing and/or other features and utilities of the present general inventive concept may also be achieved by providing a recording medium having recorded thereon a program to cause a computer to perform a method of evaluating a vocal performance of a singer using a karaoke apparatus, the method including extracting a voice energy of a singer, extracting a reference pitch using musical instrument digital interface (MIDI) data, and comparing the voice energy and an energy of the reference pitch and evaluating the vocal performance of the singer.

The foregoing and/or other features and utilities of the present general inventive concept may also be achieved by providing a method of evaluating a vocal performance, the method including determining a voice energy of a voice input to an evaluation device, determining a reference pitch energy from a recorded signal, and comparing the voice energy and reference pitch energy to evaluate the vocal performance.

The reference pitch energy may be estimated according to a frequency of one or more notes in the recorded signal.

The results of the evaluation of the vocal performance may be displayed during the vocal performance.

The foregoing and/or other features and utilities of the present general inventive concept may also be achieved by providing a method of evaluating a vocal performance, the method including comparing a voice energy of a voice to a reference pitch energy of a recorded signal, and determining accuracy of the vocal performance according to a difference between the voice energy and the reference pitch energy.

The voice energy may be compared to the reference pitch energy during the vocal performance.

The results of the determined accuracy may be displayed during the vocal performance.

The foregoing and/or other features and utilities of the present general inventive concept may also be achieved by providing a method of evaluating a vocal performance, the method including determining a reference pitch energy of a recorded note and one or more octaves above and/or below the recorded note, and comparing a voice to the reference pitch energy to determined accuracy of the vocal performance.

### BRIEF DESCRIPTION OF THE DRAWINGS

These and/or other features and advantages of the present general inventive concept will become apparent and more readily appreciated from the following description of the embodiments, taken in conjunction with the accompanying drawings of which:

FIG. 1 is a block diagram illustrating a karaoke apparatus according to an exemplary embodiment of the present general inventive concept;

FIG. 2 is a view illustrating a spectrum of the Goertzel filter according to the Goertzel algorithm;

FIG. 3 is a flowchart illustrating a method of evaluating a vocal performance of a singer according to an exemplary embodiment of the present general inventive concept;

FIG. 4 is a block diagram illustrating a karaoke apparatus according to another exemplary embodiment of the present general inventive concept; and

FIG. 5 is a flowchart illustrating a method of evaluating vocal performance of a singer according to another exemplary embodiment of the present general inventive concept.

### DETAILED DESCRIPTION OF THE EMBODIMENTS

Reference will now be made in detail to various exemplary embodiments of the present general inventive concept, examples of which are illustrated in the accompanying drawings, wherein like reference numerals refer to like elements throughout. The embodiments are described below in order to explain the present general inventive concept by referring to the figures.

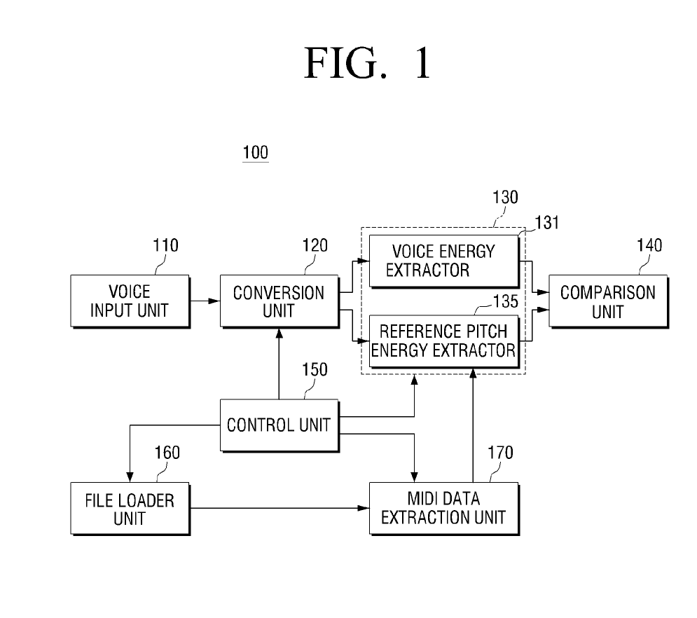

FIG. 1 is a block diagram illustrating a karaoke apparatus according to an exemplary embodiment of the present general inventive concept. The karaoke apparatus according to an exemplary embodiment of the present general inventive concept evaluates a vocal performance of a singer by comparing voice energy and energy corresponding to a reference pitch.

As shown in FIG. 1, the karaoke apparatus 100 according to an exemplary embodiment of the present general inventive concept may include a voice input unit 110, a conversion unit 120, an energy extraction unit 130, a comparison unit 140, a control unit 150, a file loader unit 160, and a musical instrument digital interface (MIDI) data extraction unit 170.

The voice input unit 110 may receive a voice signal from a singer from an outer source, such as through a microphone. The voice input unit 110 may transmit the input voice signal to the conversion unit 120.

The conversion unit 120 may convert the voice signal into a digital signal. The conversion unit 120 may transmit the digital signal to the energy extraction unit 130.

The energy extraction unit 130 may include a voice energy extractor 131 and a reference pitch energy extractor 135. The voice energy extractor 131 may extract an energy of the voice of a singer and the reference pitch energy extractor 135 may extract an energy corresponding to a reference pitch to evaluate the vocal performance of the singer.

The voice energy extractor 131 may extract the voice energy of the singer in a unit of frame using the following equation:

$${P}_{A} = {\sum }_{i = 1}^{N} {X}_{i}^{2} \qquad [ Equation 1 ]$$

wherein P_{A} denotes voice energy, Xᵢ denotes an input sample, and N denotes the size of the frame.

Meanwhile, the reference pitch energy extractor 135 may generate a reference pitch used to evaluate the vocal performance of a singer from a MIDI file and may extract the energy of the reference pitch using the Goertzel algorithm.

The Goertzel algorithm is as follows:

P_{B}=2 cos(2 πf)sᵢ₋₁sᵢ₋₂+sᵢ₋₁sᵢ₋₁+sᵢ₋₂sᵢ₋₂

wherein sᵢ=xᵢ+2 cos(2 πf)sᵢ₋₁−sᵢ₋₂, P_{B} denotes the reference pitch energy, f denotes a frequency of a note, and xᵢ denotes an input sample.

Using the above Goertzel algorithm, the reference pitch energy extractor 135 may estimate an energy having a pitch corresponding to the frequency (f). A different method other than the Goertzel algorithm may be used to estimate energy having a specific pitch. However, the Goertzel algorithm is advantageous in that it requires less computation to estimate the energy of a specific pitch.

A reference frequency may be set to be identical to the frequency of a current note (f), and the frequency width of a bin depends on the number of input samples (xᵢ). Since the frequency width of the bin increases by geometric progression as the pitch increases, the frequency width becomes narrower as the number of input samples increases.

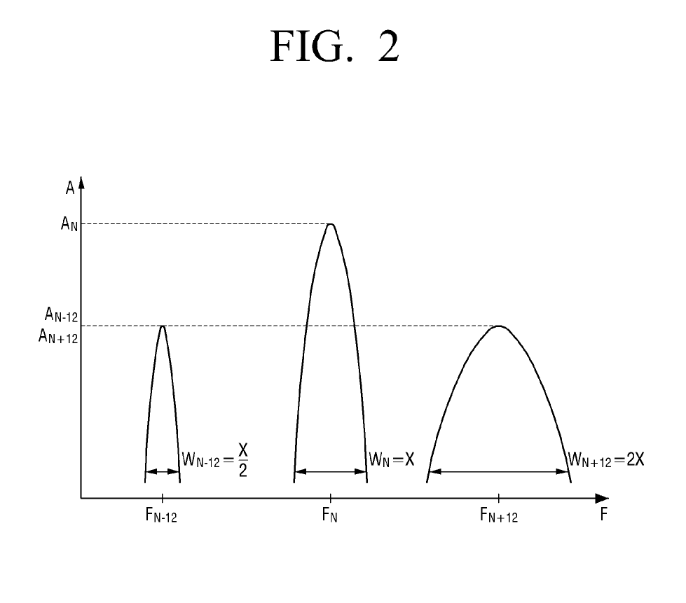

The correlation between the bins in the Goertzel algorithm will be described with reference to FIG. 2. FIG. 2 illustrates a spectrum of the Goertzel filter according to the Goertzle algorithm, wherein N denotes the number of a current note.

As shown in FIG. 2, there are 3 bins, wherein N−12 and N+12 indicate that there are 12 notes and 12 half-notes per one octave. W_{N}, W_{N-12}, W_{N+12} denote widths of the bins.

Referring to FIG. 2, there is a difference of a multiple of 2 between a previous octave and a next octave. This is because the higher the note is, the wider the frequency range, and the frequency range increases by geometric progression. Accordingly, the width of the next octave is two times larger that that of the previous octave.

The weight values given to the bins may not be the values of A_{N}, A_{N-12}, and A_{N+12} illustrated in FIG. 2. One important consideration in the present general inventive concept is the value of a first harmonic. Accordingly, the bin of the first harmonic may ideally have the largest weight value. The weight value of another bin would therefore decrease as the number of harmonics increases. This method may result in a more accurate evaluation of the vocal performance of a singer compared to a method in which the same weight value is applied.

In FIG. 2, only the 3 described octaves are illustrated for the convenience of explanation, but the number of octaves is not limited thereto. The present general inventive concept is also applicable to the case in which different quantities of octaves are presented.

The Goertzel filter can cover various octaves neighboring the octave of a current note because of at least the following reasons:

First, a singer may sing a note several octaves higher or lower than the current note. Such a singing method is typical and concerns the style preferred by a singer. Therefore, it may be unreasonable to give a penalty to the singer who sings in this manner.

Second, a singer may change the harmonic component of a multiple frequency as well as a note frequency when singing a song. The Goertzel filter is useful in estimating the harmonic component.

Referring back to FIG. 1, the comparison unit 140 may compare the voice energy extracted by the voice energy extractor 131 and the reference pitch energy extracted by the reference pitch energy extractor 135 to calculate a difference therebetween. Actually, the section of the note may be larger than one frame. Accordingly, the comparison unit 140 compares the voice energy extracted from all of the frames included in the note and the reference pitch energy.

The result of the comparison may be stored to an internal buffer (which may be a well-known type of buffer, and therefore is not shown). The result of the comparison may be thusly stored to provide a temporary result regarding the singer's vocal performance. That is, the singer can learn a temporary result of evaluating his/her vocal performance while singing a song.

Also, the result of comparison stored in the internal buffer (not shown) may be used to calculate a final score.

The file loader unit 160 may read out a song file from any of various sources, such as, for example, a compact disk or a semiconductor memory. The file loader unit 160 may divide the song file into MIDI data and accompaniment data and may transmit the MIDI data to the MIDI data extraction unit 170.

The file loader unit 160 may transmit the accompaniment data to a reproducing means (which may be a well-known type of reproducing means, and therefore is not shown) to reproduce the accompaniment regarding the song.

The MIDI data extraction unit 170 may extract the MIDI data at the same time as the singer starts singing a song. The MIDI data extraction unit 170 may extract song information such as a note number, a note starting time, a note duration, etc.

The MIDI data extraction unit 170 may obtain information regarding the lyrics of a song at a current note. The information regarding the lyrics of a song may include information regarding a location of a vowel in one or more words included in the lyrics. Since a pitch generally occurs at the vowel and does not occur at the consonant, it may be beneficial to analyze a time during which the vowel is sung to evaluate the vocal performance of a singer.

The control unit 150 the operations of the karaoke apparatus 100. More particularly, the control unit 150 may control a staring point of a song, synchronize the MIDI, the lyrics, and an audio stream, and control other operations of the karaoke apparatus 100 such as displaying the lyrics of a song, the score of a singer, etc.

Accordingly, the vocal performance of a singer can be evaluated more accurately than with the conventional methods and devices.

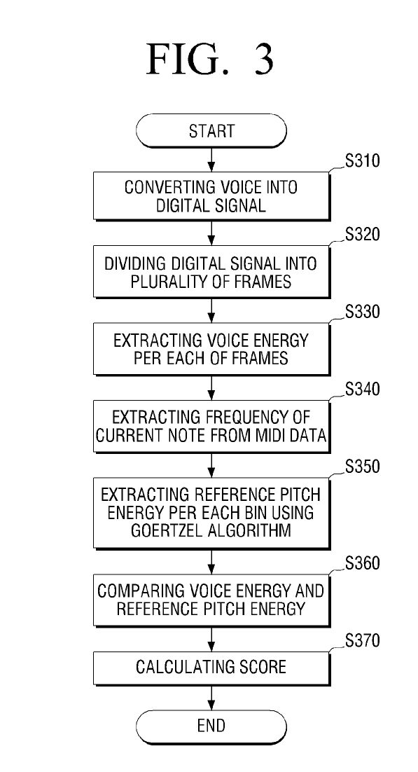

FIG. 3 is a flowchart illustrating a method of evaluating vocal performance of a singer according to an exemplary embodiment of the present general inventive concept.

The conversion unit 120 may convert a voice signal input through the voice input unit 110 into a digital signal in operation S310.

The voice energy extractor 131 may divide the digital signal into a plurality of frames in operation S320 and extract a voice energy per each of the frames in operation S330.

The reference pitch energy extractor 135 may extract the frequency of a current note from MIDI data in operation S340, and may extract a reference pitch energy using the Goertzel algorithm in operation S350.

The comparison unit 140 may compare the voice energy and the reference pitch energy in operation S360 and the control unit 150 may calculate a score according the result of comparison in operation S370.

Accordingly, the vocal performance of a singer can be evaluated more accurately than with the conventional methods and devices.

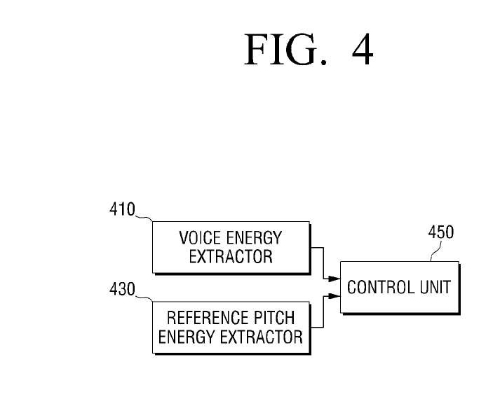

FIG. 4 is a block diagram illustrating a karaoke apparatus according to another exemplary embodiment of the present general inventive concept. The karaoke apparatus according to this embodiment may include a voice energy extractor 410, a reference pitch energy extractor 430, and a control unit 450.

The voice energy extractor 410 may extract a voice energy of a singer, and the reference pitch energy extractor 430 may extract a reference pitch using MIDI data and extract an energy corresponding to the pitch from the whole voice signal.

The control unit 450 may evaluate the vocal performance of a singer using the voice energy and the reference pitch energy.

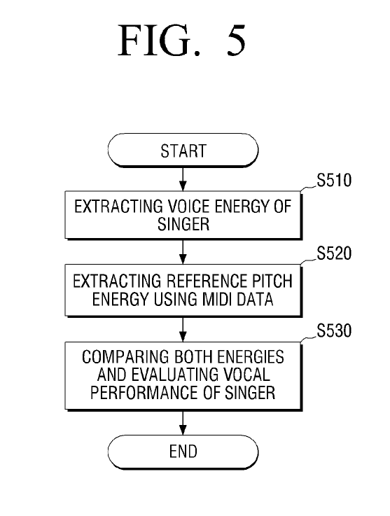

FIG. 5 is a flowchart illustrating a method of evaluating a vocal performance of a singer according to another exemplary embodiment of the present general inventive concept. In order to evaluate the vocal performance of a singer, voice energy of the singer is extracted in operation S510.

A reference pitch may be extracted using MIDI data in operation S520.

The vocal performance of the singer may be evaluated by comparing the voice energy and the reference pitch in operation S530.

Accordingly, the vocal performance of a singer can be evaluated more accurately and with a less amount of computation than that required in a conventional method and apparatus.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various example embodiments of the present general inventive concept have been illustrated and described, it will be appreciated by those skilled in the art that changes may be made in these example embodiments without departing from the principles and spirit of the general inventive concept, the scope of which is defined in the appended claims and their equivalents.

What is claimed is:

1. A method of evaluating a vocal performance of a singer using a karaoke apparatus, the method comprising:
extracting a voice energy of a singer;
extracting a reference pitch using musical instrument digital interface (MIDI) data; and
comparing the voice energy and an energy of the reference pitch and evaluating the vocal performance of the singer.

2. The method as claimed in claim 1, wherein the extracting the reference pitch comprises:
extracting the reference pitch using a frequency of a note included in the MIDI data.

3. The method as claimed in claim 2, wherein the extracting the reference pitch further comprises:
extracting the energy of the reference pitch using the Goertzel algorithm.

4. The method as claimed in claim 3, wherein the energy of the reference pitch is extracted using the following equation:
P_{B}=2 cos(2 πf)sᵢ₋₁sᵢ₋₂+sᵢ₋₁sᵢ₋₁+sᵢ₋₂sᵢ₋₂
wherein sᵢ=xᵢ+2 cos(2 πf)sᵢ₋₁−sᵢ₋₂, P_{B} denotes the energy of the reference pitch, f denotes the frequency of the note, and xᵢ denotes an input sample.

5. The method as claimed in claim 1, wherein the extracting the voice energy comprises:
converting a voice of the singer into a digital signal;
dividing the digital signal into a plurality of frames; and
extracting the voice energy of each of the frames.

6. The method as claimed in claim 1, wherein the voice energy is extracted using the following equation:
$${P}_{A} = {\sum }_{i = 1}^{N} {X}_{i}^{2}$$
wherein P_{A} denotes the voice energy, Xᵢ denotes an input sample, and N denotes a size of a frame.

7. A karaoke apparatus comprising:
a voice energy extraction unit to extract a voice energy of a singer;
a reference pitch energy extraction unit to extract a reference pitch using musical instrument digital interface (MIDI) data; and
a control unit to evaluate vocal performance of the singer using the voice energy and an energy of the reference pitch.

8. The karaoke apparatus as claimed in claim 7, wherein the reference pitch energy extraction unit extracts the reference pitch using a frequency of a note included in the MIDI data.

9. The karaoke apparatus as claimed in claim 8, wherein the reference pitch energy extraction unit extracts the energy of the reference pitch using the Goertzel algorithm.

10. The karaoke apparatus as claimed in claim 9, wherein the energy of the reference pitch is extracted using the following equation:
P_{B}=2 cos(2 πf)sᵢ₋₁sᵢ₋₂+sᵢ₋₁sᵢ₋₁+sᵢ₋₂sᵢ₋₂
wherein sᵢ=xᵢ+2 cos(2 πf)sᵢ₋₁−sᵢ₋₂, P_{B} denotes the energy of the reference pitch, f denotes the frequency of the note, and xᵢ denotes an input sample.

11. The karaoke apparatus as claimed in claim 7, further comprising:
a conversion unit to convert a voice of the singer into a digital signal,
wherein the voice energy extraction unit divides the digital signal into a plurality of frames and extracts the voice energy of each of the frames.

12. The karaoke apparatus as claimed in claim 7, wherein the voice energy extraction unit extracts the voice energy using the following equation:
$${P}_{A} = {\sum }_{i = 1}^{N} {X}_{i}^{2}$$
wherein P_{A} denotes the voice energy, Xᵢ denotes an input sample, and N denotes a size of a frame.

13. A recording medium having recorded thereon a program to cause a computer to perform a method of evaluating a vocal performance of a singer using a karaoke apparatus, the method comprising:
extracting a voice energy of a singer;
extracting a reference pitch using musical instrument digital interface (MIDI) data; and
comparing the voice energy and an energy of the reference pitch and evaluating the vocal performance of the singer.

14. A method of evaluating a vocal performance, the method comprising:
determining a voice energy of a voice that is input to an evaluation device;
determining a reference pitch energy from a recorded signal; and
comparing the voice energy and reference pitch energy to evaluate the vocal performance.

15. The method of claim 14, wherein the reference pitch energy is estimated according to a frequency of one or more notes in the recorded signal.

16. The method of claim 14, wherein results of the evaluation of the vocal performance are displayed during the vocal performance.

17. A method of evaluating a vocal performance, the method comprising:
comparing a voice energy of a voice to a reference pitch energy of a recorded signal; and
determining accuracy of the vocal performance according to a difference between the voice energy and the reference pitch energy.

18. The method of claim 17, wherein the voice energy is compared to the reference pitch energy during the vocal performance.

19. The method of claim 17, further comprising:
displaying results of the determined accuracy during the vocal performance.

20. A method of evaluating a vocal performance, the method comprising:
determining reference pitch energies of a recorded note and one or more octaves above and/or below the recorded note; and
comparing a voice to the reference pitch energies to determine accuracy of the vocal performance.
